(19) United States
(12) Patent Application Publication
(10) Pub. No.: US 2002/0087596 A1
(43) Pub. Date: Jul. 4, 2002

(54) Compact tree representation of markup languages

(76) Inventor: Steve Lewontin, (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/750,144

(22) Filed: Dec. 29, 2000

(51) Int. Cl. G06F 17/24

(52) U.S. Cl. 707/513; 707/514

(57) ABSTRACT

A document written in a markup language is represented by a unique data structure. A virtual node tree describes the structure of the data types in the document. Each one of the nodes in the virtual node tree respectively corresponds to one of the data types in the document. A data array corresponding to each one of the nodes in the virtual node tree includes information identifying the relationship of the node to other nodes in the virtual node tree and a reference indicating the location of the data corresponding to the node. A set of software components obtains the data corresponding to the nodes using the references included in the data array.

### BACKGROUND

1. Field of the Invention

The present invention relates generally to methods of representing and transferring documents written in markup languages. Particular aspects of the invention relate to a compact tree representation well suited for transferring such documents to or from a mobile device, and for creating, editing, rendering or storing such documents in a mobile device.

2. Discussion of the Related Art

Mobile devices, such as phones and handheld computers, are growing rapidly in computing power. In particular, phones can now perform many functions in addition to voice telephony (such as a phonebook, personal organizer, etc) as selections in a menu layout on a display. The menu or other user interface on a phone or other mobile device may enable the user to access remote data services, such as banking, stock quotes and weather forecasts. In particular, it may allow data or documents to be accessed from the Internet or elsewhere using the Wireless Application Protocol (WAP), and to be displayed or otherwise rendered using software including a micro-browser.

Tree representations are widely used in browsers and other software for the World Wide Web (WWW) that deal with documents marked in languages such as HyperText Markup Language (HTML), and Extensible Markup Languages (XML) such as WAP Wireless Markup Language (WML). For example, web pages are typically internally represented as trees by Web browsers and page creation tools for creation, on-screen rendering, printing, and editing. One standard tree representation of documents is the Document Object Model (DOM) specified by the World Wide Web Consortium (W3C) to represent XML documents.

However, these document tree representations tend to be large compared with the size of the original document from which the tree is constructed. Constructing them requires large amounts of memory in addition to the memory for the original document. They thus tend to be difficult to implement on mobile devices or on other devices with limited memory, such as Internet enabled cell phones.

The large size of conventional tree representations can be advantageous when fast access to document data is a high priority, such as in a Web server. However, for mobile devices, such as Internet enabled cell phones, where memory is at a premium and transmission bandwidth is relatively low, large tree representations are not feasible. Mobile devices which process hierarchically structured data, such as documents, have thus typically either not used a tree representation or have implemented only a limited, application-specific, tree representation.

The lack of a practical document tree representation for mobile and other small devices has several disadvantages. For example, trees can be used to provide a common representation of documents marked up using different markup languages. For example, Document Object Model (DOM) is a standardized, widely used document tree interface for documents marked up using any of the XML-based markup languages. When DOM is available, applications which use different XML-based languages can share common software infrastructure for parsing, representing, and accessing documents. For example, in a WAP-enabled mobile phone, the WML browser, the WAP push processing software, and synchronization software that uses SyncML can all share the same parser, tree representation and document interface. This makes implementation simpler and saves memory. This is increasingly important because standards bodies, such as WAPForum and W3C, have specified a larger number of XML-based languages as standard document formats that devices must be able to handle.

The lack of a practical document tree representation for mobile devices also makes it difficult to implement some features common in the browsers installed in the browsers of desktop computers. For example, “active content” where a Web page is dynamically generated or modified by a browser is typically implemented by manipulating a tree representation of the document.

### BRIEF SUMMARY

The present invention addresses mobile devices, software applications and data structures which are disadvantageous for at least the reasons recognized above. There are several different aspects to the invention, some of which may be practiced without the others.

One aspect of the present invention is directed to a method of representing a document written in a markup language by a unique data structure. A virtual node tree describes the structure of the data types in the document. Each one of the nodes in the virtual node tree respectively corresponds to one element of a specific data type in the document. A data array corresponding to each one of the nodes in the virtual node tree includes information identifying the relationship of the node to other nodes in the virtual node tree and a reference indicating the location of the data corresponding to the node. A set of software components obtains the data corresponding to the nodes using the references included in the data array.

### BRIEF DESCRIPTION OF THE DRAWINGS

FIG. 1 is a diagram depicting a WAP compliant mobile phone within a network infrastructure and the set of software components within the mobile phone.

FIG. 2 is a diagram illustrating the software architecture of a mobile phone including a software module according to an exemplary embodiment of the invention.

FIG. 3 is a block diagram illustrating the hardware architecture of the mobile phone according to an embodiment of the invention.

FIG. 4 is a conceptual diagram useful for illustrating the major software elements of the mobile phone according to an exemplary embodiment of the invention.

FIG. 5 is an abstract diagram of a compact tree showing the relationship of the tree description block to the raw document block.

FIG. 6 is a diagram illustrating an example virtual node structure and compact tree description block format.

FIG. 7 is a diagram illustrating the virtual tree, document block and compact tree description block of a WML example.

FIG. 8 graphically illustrates a method of reading a compact tree node.

FIG. 9 graphically illustrates a method of writing a compact tree node.

### DETAILED DESCRIPTION

The foregoing and a better understanding of the present invention will become apparent from the following detailed description of example embodiments and the claims when read in connection with the accompanying drawings, all forming a part of the disclosure of the invention. While the foregoing and following written and illustrated disclosure focuses on disclosing an example embodiment of the invention, it should be clearly understood that the same is by way of illustration and example only and is not to be taken by way of limitation, the spirit and scope of the present invention being limited only by the terms of the claims in the patent issuing from this application.

An exemplary embodiment of the present invention is a set of software modules designed to be ported to and embedded in various mobile devices, such as cell phones and handheld computers. The set of software modules contains a micro-browser which enables the mobile device to render a display of a document on the screen of the mobile device and carries out the methods described below relating to a compact tree representation of the document. The software modules preferably includes a set of software components which enables the mobile device to be WAP compliant and a set of application programming interfaces (APIs) so that applications on the mobile device can make use of the compact tree representations. However, the invention however is not limited to such a set of software modules, nor to implementation in a WAP environment or even in a mobile device.

Wireless Application Protocol (WAP)

WAP is a set of specifications, promulgated by the WAP Forum (www.wapforum.org), which defines the interfaces between wireless data devices and wired Internet devices. Designed to closely model the World-Wide Web architecture, WAP specifies all the standard naming model, content typing, content formats, protocols, etc., necessary to build a general-purpose application environment for wireless mobile devices having limited CPU speeds, memory battery life, display size, and a wide variety of input devices.

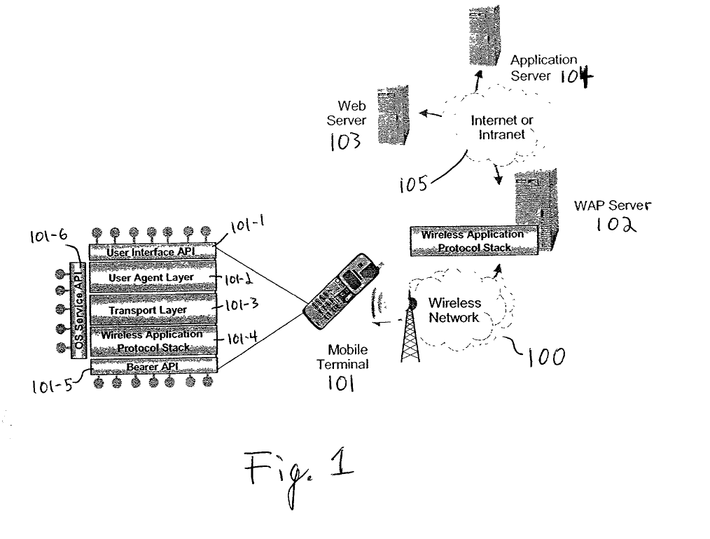

FIG. 1 illustrates a WAP-compliant (conforming to the specification provided by the WAP Forum) mobile phone 101 within a wireless network infrastructure 100. Connections from mobile phone 101 to WAP server 102 are arranged through a bearer service of wireless network 100. The WAP protocol defines a set of bearer services such as Short Message Service (SMS) and Circuit Switched Data (CSD). The WAP content may originate in WAP server 102 or may reside on Web Server 103 or Application Server 104, in which case WAP server 102 functions as a gateway to Web Server 103 and Application Server 104. Connections between WAP Server 102 and Web Server 103 and Application Server 104 are made through Internet 105 or other TCP/IP network, usually with HyperText Transfer Protocol (HTTP) messaging.

The Wireless Application Environment (WAE) model of WAP is based on the WWW client-server model and includes all elements of the WAP architecture related to application specification and execution. It specifies an application framework for wireless mobile devices with the goal of enabling network operators, device manufacturers, and content developers to develop differentiating services and applications in a fast and flexible manner. Specifically, the WAE application framework specifies networking schemes, content formats, programming languages, and shared services. Software components 101-1 to 101-5 in mobile phone 101 correspond to elements specified in the WAE application framework. The Operating System (OS) Service Application Programming Interface (API) 101-6 drawn to the left of software components 101-1 to 101-5 allows the components to interact with the operating system of mobile phone 101.

WAE does not specify any particular user agent, but only specifies the services and formats required to ensure interoperability among the various possible implementations of WAP. Furthermore, it assumes an environment in which one or more user agents providing a specific functionality may operate simultaneously. The WAP architecture (WAParch), WAE Overview (WAEOverview) and WAE Specification (WAESpec) documents from WAP Forum are hereby incorporated by reference as illustrative and exemplary, it being understood that various changes and revisions may be made to WAP and WAE (and evolution of the WAP standard would be followed by incorporating any new specified features, etc.) and that the invention is, in any event, not limited in its implementation to WAP or WAE.

Mobile Phone Software Architecture

As mentioned above, an example embodiment of the invention is a set of software modules that can be ported to and integrated into various mobile devices, such as mobile phones. The software modules consist of various components corresponding generally to User Agent Layer 101-2, Transport Layer (Loader Layer) 101-3, Wireless Application Protocol Stack 101-4 and OS Service API 101-6 in FIG. 1. It preferably allows mobile phone 101 to browse WML content and other types of content, execute WMLScript, receive and display Push messages, and receive and display Wireless Bitmap (WBMP) graphics.

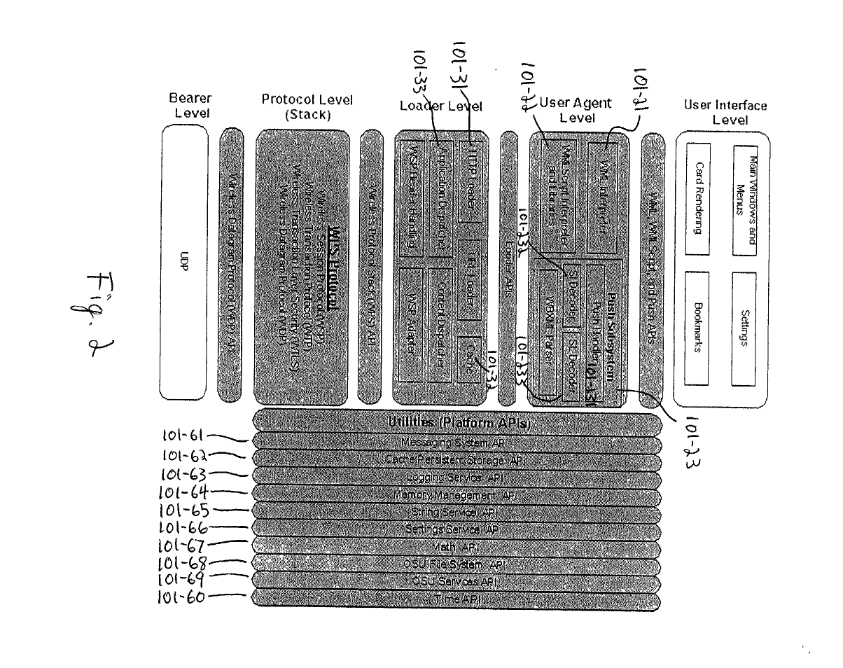

FIG. 2 illustrates how the set of software modules fits within the layered architectural framework of mobile phone 101. The components of the set of software modules are shaded. The unshaded areas, including the User Interface and Bearer level, are not part of any of the software modules. Preferably, the software modules are comprised of a group of loosely coupled components that can be used individually or together. Each component has clean lines of delineation that allows it to be used outside of the software modules.

A User Agent is any software or device that interprets resources or content (for example, WML). Text browsers, voice browsers and search engines are all user agents. WML Interpreter 101-21 handles the WML documents that have been encoded according to the WBXML specification (WBXML content) as it is received in its compressed state (WBXML format) from the WSP layer. It parses the structure of this content and passes it to user interface layer 101-1 for rendering and display to the user. WMLScript Interpreter and Libraries 101-22 interpret and execute the binary-encoded WMLScripts and performs the operations specified in the WMLScripts, interacting with WML Interpreter 101-21 as needed. Push Subsystem 101-23 receives either of the two types of Push content from Push Handler 101-231: Service Indication (SI) from SI Decoder 101-232 or Service Loading (SL) from SL Decoder 101-233. Push Subsystem 101-23 then either displays it to the user, stores it in cache, or discards it.

Transport Layer (Loader Layer) 101-3 provides functions to manage the loading and caching of WAP content based on the schema in a URL. URL-based loading uses the schema embedded in the URL to determine what loader to use. The software product includes a HTTP Loader 101-31 as well as a File Loader (not shown) and an Image Loader (not shown). Preferably, new loaders can be added to Loader Layer 101-3 as needed, such as FTP, SMTP, etc. Cache 101-32 is used to cache content in local persistent storage. It follows the HTTP model for caching and provides for Basic Authentication and Cookies. Application Dispatcher 101-33 permits an application in mobile phone 101 to register in order to receive specific content formats (identified by an Application ID) when they are received via the Wireless Protocol Stack Adapter (WPSA). When Application Dispatcher 101-33 receives a Push Message with an application ID for which an application has not registered, it aborts the (confirmed) Push message or throws away the (unconfirmed) Push message.

Protocol Layer 101-4 provides a full implementation of the Wireless Protocol Stack (WSP, WTP, WTLS, WDP) conformant with Version 1.2 of the WAP protocols and supports HTTP 1.1 functionality. It handles the connection and communication between the client and WAP server over bearer level 101-5.

The Software Utilities (Platform APIs) are a set of (potentially) platform-dependent utility functions that encompass the functionality of mobile phone 101 such as operating system services and user interface implementations. They are available to all components of the software modules, provide flexibility and enable portability. One or more sets of utility functions may need to be ported before installing the software modules in a mobile device.

Messaging System API 101-61 implements a communication channel between senders and receivers within mobile phone 101. The Cache Persistent Storage API 101-62 provides an interface to a device's persistent storage in order to write, retrieve, and delete content. The Logging Service API 101-63 enables the storing of logging messages for debugging purposes. The Memory Management API 101-64 allocates and frees memory. The String Service API 101-65 enables the manipulation of strings. Settings Service API 101-66 enables the storing and retrieval of key settings such as the address of the WAP gateway, cache size, temp file folder location, etc. OSU File Service 101-67 implements a simple file system on a device's persistent storage. OSU Services 101-68 provides operating system utilities such as mutexes, signals, and threads. Time Services API 101-69 enables the setting and conversion of time values. Math Utilities API 101-60 provides functions for 64-bit integer arithmetic and floating point operations.

There are, of course, a number of APIs (not shown) acting as the interface between User Interface level 101-1 or Bearer Level 101-5 and the various components of the software modules. The APIs preferably include the following. A URL Loader API retrieves resources and content. An Image Loader API enables the asynchronous retrieval of images. A WML Interpreter API initializes the WML Interpreter, requests information about the WML Interpreter state, and initiates browsing of content. A WML Interpreter UI API handles user interaction with, and rendering of, WML cards. A WMLScript API provides an interface between a user interface and the WMLScript Interpreter, and handles dialog interactions. A WMLScript UI API provides the functions implemented by a UI and called by the WMLScript Interpreter in order to display dialogs. A WPSA API enables applications to receive content from the protocol stack. An Application Dispatcher API enables applications to receive messages based on application ID. A Content Dispatcher API enables content handlers to receive messages based on content type. A Session Initiation API starts a session. A Service Indication API enables the parsing and display of an SI Push message. A Service Loading API enables the parsing and display of an SL Push message. A multipart Data Parser API implements the reception and decoding of multiparty form content.

Mobile Phone Hardware Architecture

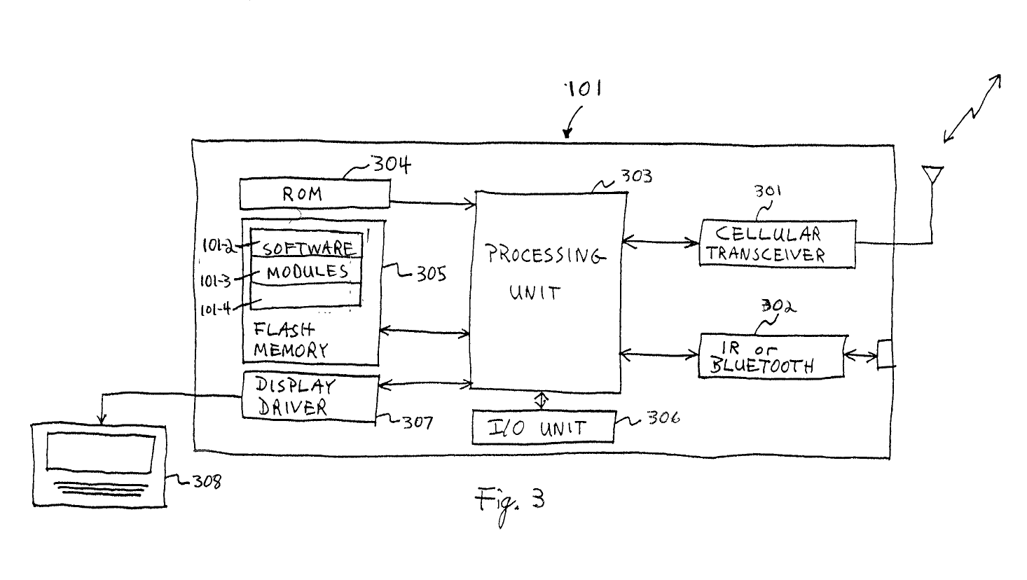

A block diagram of the possible hardware architecture of mobile phone 101 according to an exemplary embodiment of the invention is shown in FIG. 3. It should be understood that the invention is not limited to a mobile phone having such a hardware architecture.

Mobile phone 101 has a standard cellular transceiver 301 connecting it to a cellular communication network (not shown) and a standard infrared (ir) or Bluetooth wireless port 302 enabling it to directly receive data from another device via a wireless connection. A processing unit 303 is connected to a read-only memory (ROM) 304, a persistent storage (such as flash memory) 305, an input/output unit 306, and a display driver 307 connected to display 308. Although display 308 is shown separately in FIG. 3 for simplicity, it is preferably formed integrally with the mobile phone. A variety of software applications, including the software modules according to the example embodiment of the invention, are included and stored in ROM 304 or persistent storage 305 of mobile phone 101, but are not shown in FIG. 3 for the sake of convenience.

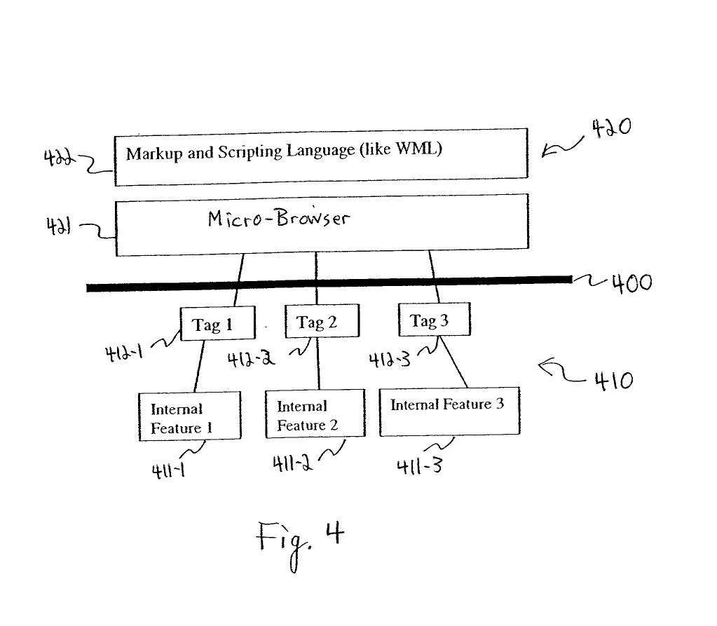

As shown in FIG. 4, the software of mobile phone 101 has a kernel space 410 and a software application space 420 separated by line 400. The kernel space 410 may be composed of hardware, firmware and/or an operating system. In any case, the software in kernel space 410 has a plurality of internal features 411-1 to 411-3, each internal feature providing a unique functionality application. The functionality applications are preferably precompiled using a low level language like ANSI C. A plurality of tags 412-1 to 412-3 are each associated respectively with internal features 411-1 to 411-3. Although three internal features and associated tags are shown in FIG. 4, a mobile phone may have any number of internal features and associated tags.

The software modules according to the example embodiment of the invention is located in software application space 420 and communicates with internal features 411-1 to 411-3 and other parts of kernel space 410 via corresponding predefined tag handling subroutines (not shown). The markup language and scripting language 422 run on top of micro-browser 421. They access the functionality of internal features 411-1 to 411-3 by special tags (not shown) in the scripting language (e.g., a CALL tag in WMLScript).

The User Agent Layer 101-2 uses the functionality of one of internal features 411-1 to 411-3 via one or more Program APIs in OS Service APIs layer 101-6, thus making it possible to accept input from the user and to compute based on the input.

Compact Tree Representation—Introduction

Compact document trees according to the example embodiment of the invention provide a highly compact and very small document tree representation of documents such as Web pages. They improve on previous tree representations because the size of the tree representation is small compared to the size of the original block of data. Although, they are well adapted to implement a general tree interface to documents on mobile devices with limited memory and transmission bandwidth where conventional tree representations are not practical, they may also be useful where conventional tree representations would also be practical. This may be desired, for example, to achieve interoperability between among many different types of devices.

Because of the small additional size of the tree description block, compact trees also provide an efficient serialization mechanism. This makes it possible to pre-compute and transmit compact trees to devices with limited persistent storage and limited transmission bandwidth. Although access to the raw data associated with compact tree nodes is less efficient, requiring more computation, transmission of pre-computed compact trees in serialized form to can to some extent offset this disadvantage.

The lack of a functional, high-level tree interface to documents has made it especially difficult to implement features that are now widely available on desktop browsers, such as active content. This also makes it difficult to implement handling of new markup languages since much of the processing code has to be rewritten at a low level. With compact trees according to the example embodiment of the invention, it is possible to implement advanced browser features such as active content, and it is easier to adapt device software such as browsers to new markup languages.

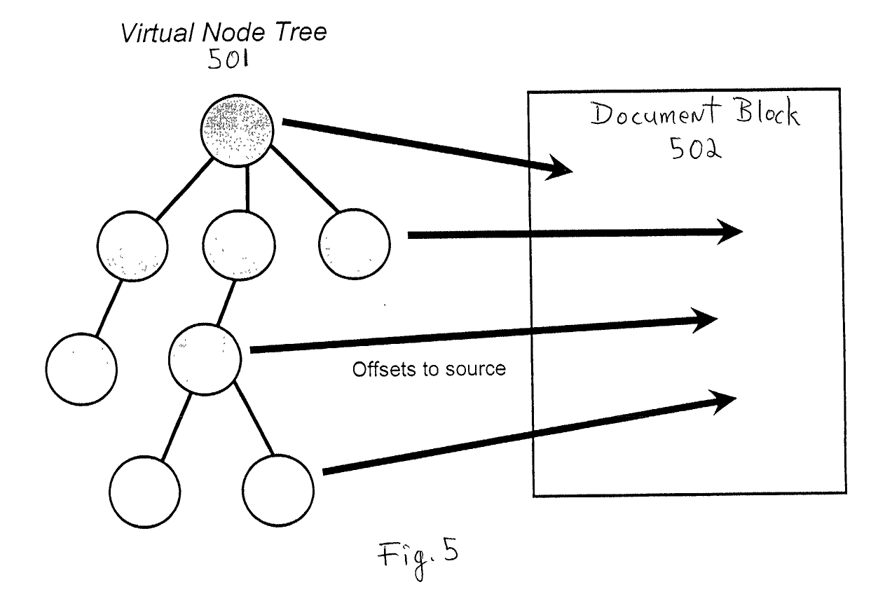

The compact tree representations according to the example embodiment of the invention are small because they create only a minimal size “virtual document tree” object which contains none of the actual document data. As illustrated in FIG. 5, this vrtual node tree 501 is linked to the original document contents by processing components that allow the tree elements to be read and written exactly like a conventional document tree. By storing all of the document data in the original document, compact trees avoid copying, even temporarily, any document data when creating the tree representation.

The compact tree description block is itself a minimal representation of the tree structure. Unlike a conventional tree representation where tree nodes of different types contain different data, all of the elements of the compact tree description block can be of a fixed size. This makes it possible to construct a compact tree from a document with only a single memory allocation whose size can easily be pre-calculated. This greatly simplifies memory management on a mobile device using compact trees.

The compact trees according to the example embodiment of the invention can be used to represent documents internally in a computer program that uses tree structures for its operation; and to serialize trees for storage and/or transmission between mobile devices. They can be used in a WAP micro-browser on a mobile phone which downloads a WML deck and constructs a compact tree description block for use in rendering the deck on a display screen. They can also be used in a Web server which creates a compact tree description block from a document, stores the compact tree description block on a storage medium (such as a disk drive), and transmits both the document and compact tree to a Web client. The micro-browser can then use the received compact tree as its internal representation of the document for rendering.

The compact tree can be built from an existing block of raw document data, for example by a WAP browser which builds a tree for displaying a downloaded WML deck based on the raw WBXML. However it is also possible to build a tree and the associated raw document simultaneously or to extend a block built from pre-existing raw document data. That is, compact trees can be both read and written.

The compact tree representations can be used to access the document data via the tree nodes in the same manner as conventional tree representations. For example, a computer program can examine the tree, select a node, and extract some data from the node. With a tree constructed from an XML document, a software component can find the node representing a specific XML tag and extract the value of some attribute of that tag. However, because the nodes of a compact tree description block contain only the tree structure and not the raw data itself, the compact tree representation requires an additional component to interpret or write the raw document data associated with a specific node.

The specific interpretation/writing components depend on the format of the raw document data. To read data from a compact tree, a set of data decoders called “type deserializers” is associated with the tree. Each type deserializer is capable of reading the raw data associated with one of the data types used in the raw document. To read data from a node, the data type and location in the raw document is identified, and the appropriate type deserializer is invoked to read the data. To write data, a set of type serializers is used in a complementary fashion.

Because of the limited memory required to store and construct them, and the limited bandwidth required to transmit them, compact trees according to the example embodiment of the invention are especially suitable for mobile devices with limited memory or limited transmission bandwidth such as mobile phones, hand-held computers, and embedded applications. For example, the compact trees can be used as a common internal representation for any markup language processing task, such as WML browsing, handling of push content, and synchronization in a WAP phone.

Compact Tree Representations—Details

A compact document tree is a data format composed of a raw block of document data and a compact tree description block which provides a description of the raw data as a tree.

A tree is a data structure composed of tree nodes. Tree nodes are data structures that contain links to other tree nodes such that the linked nodes form a branching structure like a tree. One common form of tree has a single root node which has links to child nodes; each child node has links to further child nodes; and so on to form the branching structure of the tree. Such a tree can be constructed from nodes each of which contains only two links: one to the first child and one to the next sibling. Besides links to related nodes, a tree node also must contain data elements describing the node itself. (Trees are widely used in computing, and the specific form of tree described here is well known in the art.)

A document is a block of data marked with tags, such as a Web page or a WAP WML deck. Such documents may contain plain text (as in the case of an HTML Web page) or they may be in an encoded form (such as WAP WBXML). Such documents contain elements delimited by begin tags and end tags. The document contains tags delimiting a root element; within the root element may be contained further tags delimiting other elements; each of these elements may in turn contain further tags delimiting other elements; and so on. Such a document can thus be described by a single-rooted tree whose root node corresponds to the root element. Processing such documents by software commonly involves generating such a tree structure.

In a compact tree according to the example embodiment of the invention, the tree description block contains data structures forming a tree as described above. However, the data associated with each node is represented within the node only as a field containing the location of the start of the associated data within the raw document block. So, for example, in the case of a tree constructed from an XML document, the node representing the root element contains a field giving the location of the beginning of the root element in the raw XML document block.

As illustrated in FIG. 5, the complete compact tree representation is therefore composed of both virtual node tree 501, containing nodes which hold locations in the raw document block, along with the raw document block 502 itself. The tree description block alone is not a complete representation of the tree. The data associated with each node is extracted by using the location stored in the node to find the start of the associated data within the raw document block. These data are only available as long as the association between the tree description block and the raw document block is maintained.

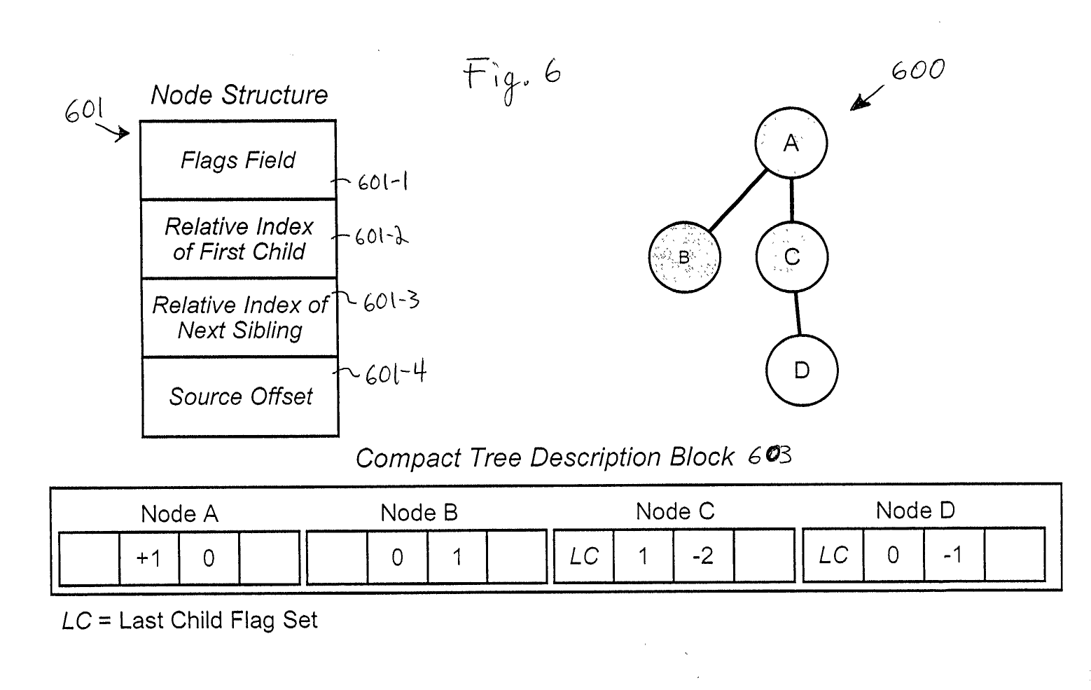

There are different possible forms of the tree description block. FIG. 6 illustrates one form of tree description block consisting of an array of fixed length node structures 601 for each node in the virtual node tree. The respective node structure for each node contains four data items or fields: a flags field 601-1, a child index 601-2, a sibling index 601-3, and a source offset 601-4.

Flags field 601-1 contains several flags. The last sibling flag is used to indicate that the node is the last sibling in a list of siblings (which may contain one or more nodes). Other flags may be used to identify the type of the node data. The flags may be represented in any way that permits several non-mutually exclusive values to be set, such as a bit field.

Child index 601-2 is the array index of the first child of the node relative to the index of the node itself. Alternatively, it may be an absolute index of the child node in the array or the absolute address of the child node. A distinguished value such as zero indicates that there are no child nodes.

Sibling index 601-3 is the array index of the next sibling of the node relative to the array index of the node itself. Alternatively, it may be an absolute index of the sibling node in the array or the absolute address of the sibling node. If the node is the last sibling, it is the relative index, absolute index or absolute address of the parent node. If the node is the root node, a distinguished value such as zero indicates that there is no parent node. When the node is the last sibling, the last sibling flag is set. When the node is not the last sibling, the last sibling flag is unset.

Source offset field 601-4 contains the offset from some known location in the raw document (such as the beginning of the document) of the start of data corresponding to this node.

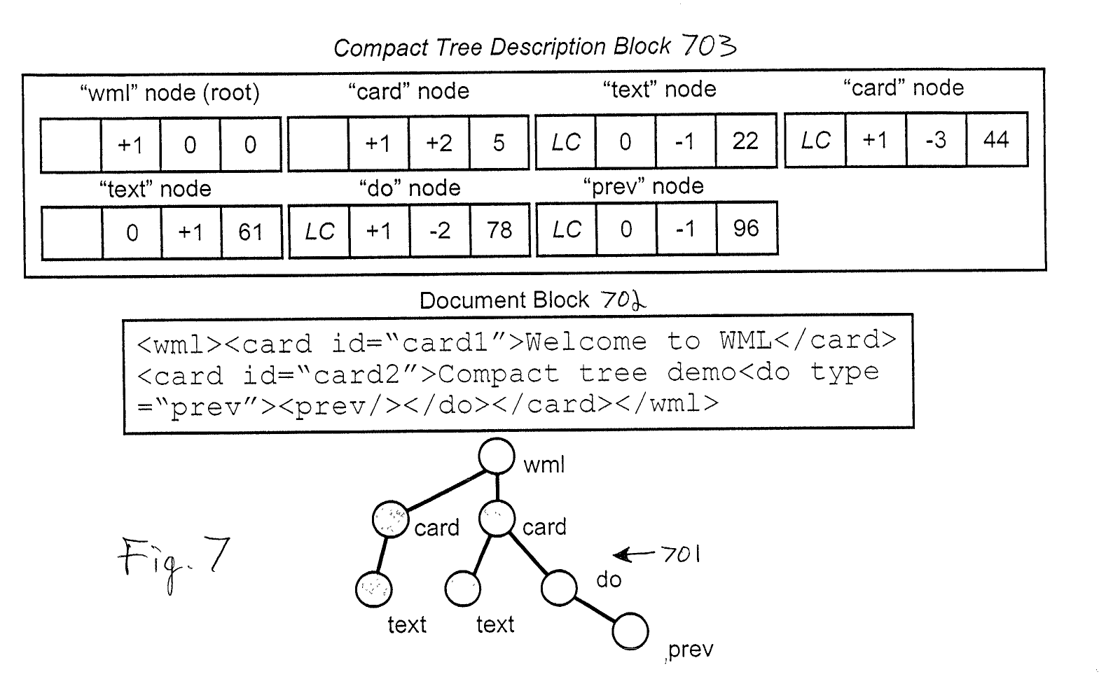

Merely as an example, virtual node tree 600 in FIG. 6 has four nodes A, B, C and D and a corresponding compact tree description block 603. A WML example is provided in FIG. 7 in which the virtual node tree 701 for document block 702 contains many elements common to WML, such as the card element, the text element, and the do element. The compact tree description block 703 includes the node array for the “wml” node as well as the other nodes.

While specific examples are provided in FIGS. 6 and 7, the actual representation of each of these node fields is not specified and may be configured according to the requirements of the software and platform using the compact tree. For example, the lengths of the index and offset fields may be set in such a way that the total size of the nodes is the minimum required to reference a given number of nodes and a given range of raw document block locations. For example, with relative indexes represented by eight-bit signed integers, the total possible number of nodes is 128. With source offsets of 16 bits, the maximum possible raw document size is 64 K. For very small documents, such as WML decks, it is possible to construct a tree with nodes as small as 5 bytes each.

In another form of tree description block, the nodes contain variable length fields so that the node lengths are not fixed. With variable length nodes, trees whose size cannot be predetermined can be represented in very compact form. However, trees with fixed length nodes may be simpler for computational purposes since the description block can be treated as an array of a single type.

Other forms of tree description block are possible as long as they meet the basic requirement of providing tree links and locations of data items within the raw document block. For example, the use of a flags field to indicate the type of the data item associated with a node is a useful optimization that makes decoding the data easier, but is not required. Also, tree links need not be expressed as relative indexes nor the source locations as offsets. For example, it is possible to use absolute indexes or absolute addresses of locations in memory instead of relative indexes, and it is possible to use absolute addresses of locations in memory instead of source offsets. It is also possible to construct trees with other topologies, such as trees in which nodes can have more than one parent and in which there can be more than one root. It is also possible to implement trees with more than two link fields for greater efficiency in finding node relations. However, most such tree implementations will be larger than the implementation described here.

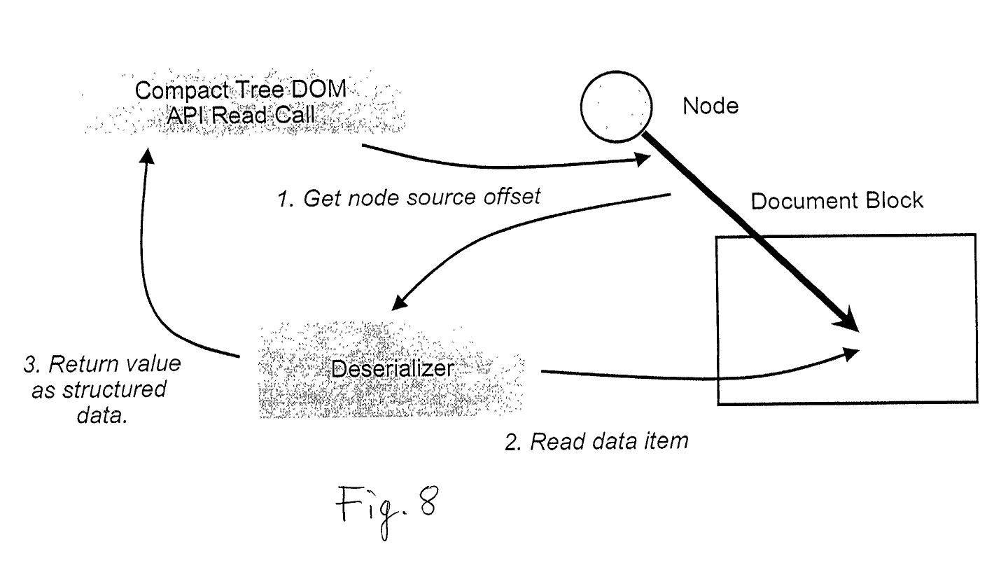

FIG. 8 graphically illustrates a method of reading data from a compact tree. The data item associated with each compact tree node has some implicit type. The possible types depend on the nature of the raw document and its encoding. For example, in a tree created from an XML document, the data item associated with a node may be of type element, attribute, text, or a variety of other types defined by XML grammar.

However, the types of elements stored in a document typically do not correspond to the storage types which are operated on by programs. Programs operate on primitive data types of various lengths, such as chars, integers, pointers and structured data elements built from these primitive types. Moreover, the same types may be stored differently in different computers. For example, integers may be stored with different byte orders. Because of these differences, it is generally not possible to treat a data element contained in a raw document as if it were one of the internal types used by a program. For example, if a program has the address in memory of some element of a raw document, it cannot typically treat this as the address of some structured data type understood by the program. Instead, programs which wish to operate on raw document data need some component to convert back and forth (serialize and deserialize) the data between raw document storage data and structured, typed, data. Since compact document trees use the raw document to store all of the document data, reading or writing any data element from the tree requires deserialization or serialization of the raw document data.

In order to read the data from a compact tree, the tree is associated with a set of type deserializers, only one of which is shown in FIG. 8 and each of which is capable of decoding raw data of a specific type by reading the raw document buffer at the location of the data item. A type deserializer would typically be implemented as a software component and function so that it can be called with the location of an item of raw data and return the data values associated with that item. Reading the data from a node can then be accomplished by the following method steps:

1. The beginning location of the raw document data for the node is read from the node source offset field.

2. The type of data for the node is identified and the data item is read. If the node flags field contains type information, this is used to identify the type of data. Other methods of identifying the data type are also possible, such as examining the raw document data to determine the type heuristically.

3. The type deserializer for the appropriate type is invoked to decode the data and return the data values as structured data.

This method differs from conventional methods of reading data from a conventional tree node which would typically involve reading structure, typed data values directly from the node or from addresses contained in the node. However, other operations on the compact tree are similar to those for more conventional trees, such as locating a node or set of nodes by following the links from related nodes.

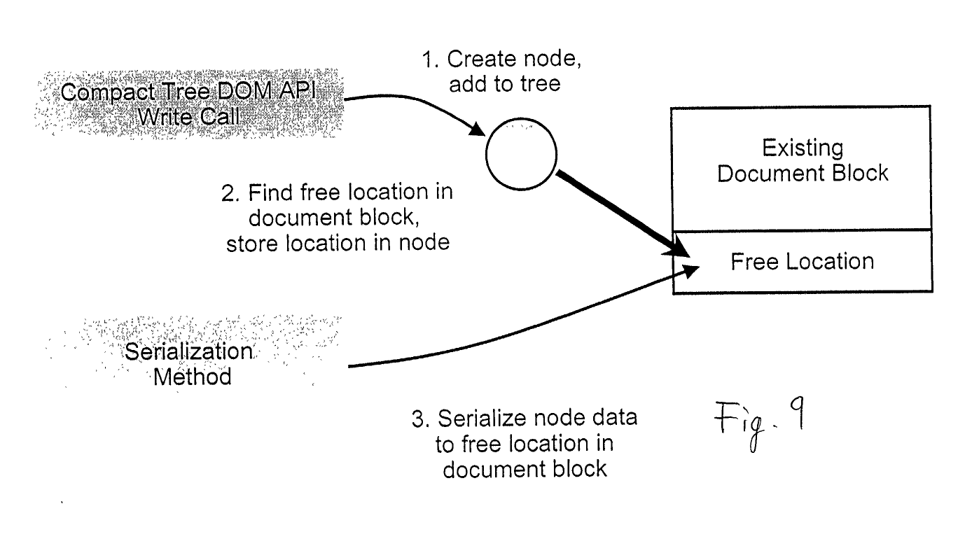

As illustrated in FIG. 9, writing a compact tree basically follows the inverse of the reading process, using type serializers to write the data. However, a practical implementation of writing preferably stores the raw document data somewhat differently from the one described above. Because of this, and because a read-only compact tree implementation based on the component mechanism described here is extremely useful in its own right, a writable tree implementation is discussed below as an extension to the compact tree model described thus far.

One way to construct a compact tree is to generate a compact tree description block from an existing document. Building document trees from existing documents is a common operation of software, such as browsers, that processes XML and XML-like markup languages. (Alternatively, a tree can be built from scratch by writing nodes, as described below.) The method for generating a tree description block from an existing block of hierarchically structured data is not substantially different from the method of generating a conventional tree representation from the same data. Typically, the raw document block is processed by a parser which understands the structure of the document data. As each element is encountered by the parser, a tree node is added to the tree description block.

The specific form of the compact tree description block described above makes certain optimizations possible when generating the tree. Specifically, because the nodes are of a fixed size and are treated as members of an array, it is possible to pre-allocate a single block of data of the exact size of the tree description block. One method to accomplish this is to parse the raw document block in two passes. The first pass counts nodes and then allocates a single block big enough for all the nodes. The second pass fills in the node array with data for each node.

These methods for generating trees by parsing are widely known and commonly used. They are mentioned here merely to demonstrate the feasibility of compact trees and some advantages of the specific compact tree format according to the example embodiment of the invention.

One way to modify or create a compact tree from scratch is to continuously modify the raw document block either by writing to it with type serializers or deleting sections of raw data, while simultaneously updating the tree description block. This results in a tree that is indistinguishable from a read-only compact tree, but would be an extremely cumbersome mechanism for two reasons. First, constant recopying of raw block data and frequent reallocation of raw block space would be required to continuously update the raw block as space was opened for new elements or removed for deleted elements. Secondly, with every change in the raw block, much of the compact tree description block would also have to be updated to reflect the new locations of any raw block elements that were moved.

Preferably, trees updated or created from scratch differ slightly from trees that are generated by parsing an existing raw document. In particular, the raw document block no longer necessarily contains data in the same order as a normal raw document, and the space efficiency may be somewhat less. However, such a tree can be read exactly like a read-only tree.

In this method, the existing raw document block 900 contains or has added to it free space into which new raw data can be written, and the tree description block contains or has added to it free space from which new nodes can be allocated. The free space can be located anywhere, although in the implementation described here the free space is located in blocks specifically allocated to hold newly written data and newly written raw document data is added, in order of writes, from the beginning of new raw data blocks.

To add a new node to the tree (step 1 in FIG. 9), the node is allocated from the free space in the tree description block and the new raw data is then written into the first available free location 901 in the existing raw document block 900 (step 2). The location of the new raw data is arbitrary in relation to any other data the raw document block may contain, so that, for example, if the raw block already contains an existing document, the new data is not necessarily written in such a way as to be consistent with the existing document organization.

A set of type serializers is instantiated, only one of which is shown in FIG. 9 and each of which is capable of writing the raw data corresponding to some data element. These are preferably implemented as a set of functions that can be called with parameters that describe the raw data and the location to which it is to be written.

A block of raw data space and a block of tree description block space are pre-allocated to hold new elements. These blocks can be of any convenient size, but they should each be big enough to hold at least one element. If a tree is being constructed from an existing raw document block and the tree is intended for modification, it is convenient to allocate some extra space when the original document space is allocated.

To add a new node, the first free space available to hold the raw data for the new node is located and the raw data is written into this space. The data is written using a type serializer capable of encoding the data type associated with the node (step 3 in FIG. 9). The first free space available to hold a tree description block node is located and the node structure is written into this space. The location field of the node is filled in with the location of the newly written raw data.

To delete a node, the node data in the tree description block are marked as free (for example, by setting a flag in a flags field), and the related nodes have their links updated to remove their connection with the removed node. The associated raw document data is not modified or deleted.

New blocks are allocated as needed to provide space for new nodes and raw document elements. These can be allocated using any software component and need not be located contiguously with existing blocks. However, in order to maintain the memory advantages of treating the tree description block as an array of fixed size elements and the raw document block as a continuous block of data, it is useful to implement an allocation scheme that treats allocated blocks as virtually contigous.

Using this implementation, newly allocated raw document data is not necessarily formatted according to the syntax of a normal raw document. However, any existing raw document data is maintained unchanged and can be recovered. For example, if a WBXML document is modified using this method, the existing block of WBXML is maintained unchanged. However, additional blocks of raw data containing small sections of WBXML data are added to the original document. These additional blocks cannot necessarily be read (for example, by a WBXML parser) as a standard WBXML document since they probably do not form a complete document and may be in any order. However, a writeable tree constructed using this method can be read exactly like a read-only compact tree, using the method described with reference to FIG. 8.

With a writable tree implementation, the type deserializers are preferably capable of reading elements of raw data that are not in the context of a complete document. Specifically, each type deserializer is preferably able to recognize where an element ends even when the element is not in the context of an existing document, which might normally mark the end of an element by the following context. Such type deserializers may be a modification of the type deserializers used in a read-only compact tree implementation. Alternatively, there may be an implementation of type serializers that add enough context to each element so that the end can be recognized.

Although a tree written by this method can be read exacty like a read-only compact tree, it may not be as space-efficient for two reasons. Since it may be necessary to add some context to raw data elements so that they can be deserialized correctly, raw elements may be larger. However, any additional space required should typically be quite small. For example, with WBXML, the only additional raw data required is to encode code pages, and most WBXML documents contain little or no code page data. Depending on the allocation mechanism for new blocks, some allocation overhead (such as block headers) may also be required.

Given that the extra space required is small, these are reasonable tradeoffs for a much simplified implementation of write capability.

Compact trees save space and provide size advantages in two ways. The additional overhead of the tree representation beyond the raw document data is only the additional size of the compact tree description block. This minimizes the space required to store, or the bandwidth required to transmit, such a tree representation compared with the space or bandwidth required for the raw data alone. Only enough additional memory space to hold the description block itself needs to be allocated to construct a compact tree from an existing block of raw document data. Since the raw data itself never needs to be copied or duplicated into the tree representation, compact trees avoid the need to allocate space, even temporarily, for copying data.

Also, since the components of the tree description block can be of a fixed size, known before the tree is constructed, it is possible to calculate the size of a compact tree description block for an existing document before the tree is constructed. In many cases this can make it possible to manage the allocation of memory for the tree description block in such as way as to save space (for example, by avoiding fragmentation).

Compact trees may be used either as an internal representation of tree structure used by computational algorithms that require tree structures or as a method for storing and exchanging tree-structured data. When used as an internal representation, compact trees are implemented in whatever way is most suitable to the computational algorithm using them. For example, the tree description block may be implemented as an array stored in memory, using whatever data structures are required by the algorithm and the computing system and language used to implement the algorithm. Such a representation is internal in the sense that it is used by the computational algorithm in ways and in a form that may not be known outside the algorithm.

Compact trees can also be used as compact way to store and exchange pre-computed tree representations along with raw documents. That is, they can be used as an efficient serialization format for tree-structured documents. Such a format can, for example, be used to store documents along with their tree representations on disk or to exchange them between computers via networks. One example of such a format would be a multi-part file in which one part contains the raw document block and the other contains the compact tree description block. A serialized tree differs from an internal tree in that the format in which the tree is stored is typically known independently of any algorithm that uses the tree. This permits the serialized tree to be easily used by multiple programs and easily exchanged among devices.

A serialized tree may be stored in a form that can be read directly into computer memory in such a way that it can be used as an internal representation, but typically this will not be the case, since internal data representations may differ among computing platforms. Instead, computing systems will typically process serialized trees by deserializing them to create whatever internal format is convenient or required by the algorithms that will use the trees. Because of this, serialized trees may be structured in ways that make storage compact but which would be computationally inconvenient as an internal representation, such as using variable length nodes in the compact tree description block. A tree description block with variable length nodes is computationally more complex as an internal tree representation than the fixed-size node implementation described above (for example, because nodes could not be accessed as array members), but this is an extremely compact serialization format since node size would always be the minimum required for a given document.

A number of additional uses of the structure of compact trees and methods for reading and writing node data are possible. A specific serialization format may serialize compact trees with variable length tree nodes as multi-part documents. Also, a compact tree encoder may implement a memory-efficient component for generating a raw document block from a read/write compact tree. A raw document is an encoding of data with a particular format. For example, XML documents can be encoded either as simple text or in binary format (WBXML). Using the compact tree encoder, a device can construct a compact tree and then output an encoded document from the constructed tree for storage or exchange with other devices. An example would be synchronization software in one device which constructs a Synchronization Markup Language (SyncML) compact tree and then outputs a WBXML-encoded SyncML document to another device in order to accomplish synchronization.

While the foregoing has described what are considered to be example embodiments of the invention, it is understood that various modifications may be made therein and that the invention may be implemented in various forms and embodiments, and that it may be applied in numerous applications, only some of which have been described herein. It is intended by the following claims to claim all such modifications and variations.

1. A method of representing a document written in a markup language, the method comprising:
providing a virtual node tree describing the structure of the data types in the document, each one of the nodes in the virtual node tree respectively corresponding to one element of a specific data type in the document;
for each one of the nodes in the virtual node tree, providing a data array including information identifying the relationship of the node to other nodes in the virtual node tree and a reference indicating the location of the data corresponding to the node; and
obtaining, by a set of software components, the data corresponding to the nodes using the reference included in the data array.

2. The method recited in claim 1, wherein the data in the document is stored in a document block in memory.

3. The method recited in claim 2, wherein the document is written in XML or a variation of XML.

4. The method recited in claim 1, wherein the data arrays further include a flags field.

5. The method recited in claim 4, wherein a flag in the flags field indicates whether or not the node is the last sibling in a list of siblings.

6. The method recited in claim 4, wherein a flag in the flags field identifies the type of the node data.

7. The method recited in claim 1, wherein the relationship of the nodes to the other nodes in the virtual node tree is indicated by a child index and a sibling index in the data array.

8. The method recited in claim 1, wherein the data arrays have a fixed length.

9. The method recited in claim 1, wherein the data arrays have a variable length.

10. A mobile phone comprising:
a set of software components;
a memory connected to the set of software components; and
a display,
wherein at least one of the set of software components carries out a method of representing a document written in a markup language and rendering the document on the display, said method comprising:
providing a virtual node tree describing the structure of the data types in the document, each one of the nodes in the virtual node tree respectively corresponding to one element of a specific data type in the document;
for each one of the nodes in the virtual node tree, providing a data array including information identifying the relationship of the node to other nodes in the virtual node tree and a reference to the location of the data corresponding to the node; and
obtaining the data corresponding to the nodes using the references included in the data array.

11. The mobile phone recited in claim 10, further comprising a browser or other software application adapted to receive said document and render said document on said display.

12. The mobile phone recited in claim 10, wherein the document is an XML document and the browser is an XML browser.

13. The mobile phone recited in claim 10, wherein the data in the document is stored in a document block in said memory.

14. The mobile phone recited in claim 10, wherein the data arrays further include a flags field.

15. The mobile phone recited in claim 14, wherein a flag in the flags field indicates whether or not the node is the last sibling in a list of siblings.

16. The mobile phone recited in claim 14, wherein a flag in the flags field identifies the type of the node data.

17. The mobile phone recited in claim 10, wherein the relationship of the nodes to the other nodes in the virtual node tree is indicated by a child index and a sibling index in the data array.

18. The mobile phone recited in claim 10, wherein the data arrays have a fixed length.

19. The mobile phone recited in claim 10, wherein the data arrays have a variable length.
